(19) United States
(12) Patent Application Publication
(10) Pub. No.: US 2022/0114599 A1
(43) Pub. Date: Apr. 14, 2022

(54) CONFORMITY ASSESSMENT TOOL FOR ONLINE PLATFORMS

(71) Applicant: COLLABOFIDE INC., Ottawa (CA)

(72) Inventor: SUZANNA ERSOY, Ottawa (CA)

(21) Appl. No.: 17/241,802

(22) Filed: Apr. 27, 2021

(30) Foreign Application Priority Data
Apr. 27, 2020 (CA) 3078051

(51) Int. Cl. G06Q 30/00

(52) U.S. Cl. CPC G06Q 30/018

(57) ABSTRACT

There is provided an assessment tool for online platforms. The tool trains consumers to be assessors, vis-a-vis national regulations, international standards and best practices. The assessors complete an assessment of an online platform by comparing merits of the online platform against international standards. The assessors may be compensated. A report can be produced based on the assessment; the report can be displayed so that a third party (consumer, regulator, investor, partner, etc.) can determine the legitimacy and viability of the online platform. A mark of trust is provided to the online platform.

### CROSS-REFERENCE TO RELATED CASES

This application claims the benefit of Canadian patent application Serial No. 3,078,051, filed on Apr. 27, 2020, and incorporates such application by reference into this disclosure as if fully set out at this point.

### TECHNICAL FIELD

The present application exists in the field of quality control, auditing, certification, conformity assessment, review processes, trust building mechanisms, and standards related thereto. The present invention relates to a system and method of assessing the conformity of online businesses, namely online platforms, using paid consumer assessments against established international standards, best practices, and regulations and providing a mark of trust relating to the results of the assessment.

### BACKGROUND

The trust deficit is one of the most significant barriers inhibiting small and medium size (SME's) businesses, particularly those who are online, from closing more deals and generating greater sales. These businesses are competing with large online platforms such as Amazon, Shopify, Facebook, Instagram, etc. To build trust with their consumers, with additional partners, and with regulators, online platforms have to spend a lot of resources (time/money) for social media presence (pay influencers, marketers, reviews). However, social media popularity does not equal legitimacy, ethical behaviour, and compliance with national and international standards and best practices.

Today, there isn't a mechanism or a body (an organization) that verifies whether claims and statements made online are true. With the world moving into the online marketplace, consumer confidence is measured by the magnitude of online reviews. Compliance with existing regulations is overlooked and often ignored because there is very little information about it and because the process is highly complex.

One way traditionally to assure compliance is to hire auditors who can certify that the online business is legitimate and compliant. However, this approach is expensive, and many online platforms and businesses do not have the resources to obtain such certifications. In addition, since certification is currently a static pass-fail process, it is highly inapplicable for online platforms who often change their strategies, services offered, and branding. For this reason, many online businesses bypass traditional certification and build trust through social media channels and spend a lot of time and resources on marketing, branding, and influencers.

With online businesses emerging daily, consumers use ‘online reviews’ as an indicator of confidence. However, online reviews are often unreliable because one cannot track if the reviews are authentic; if the reviewers are paid for their feedback and/or if negative or unfavorable reviews have been deleted. The online marketplace is largely unregulated, and many online businesses are free to operate as they wish. The assumption is that when a consumer is online, the consumer takes the risk and must use a “leap of faith”.

Additional issues with reviews are that they are aimed at reviewing products and/or services, but not the business practices of a platform (i.e., fair, transparent, anti-discriminatory, ethical, inclusive, legally compliant, etc.). Online companies or platforms will spend a lot of money to appear trustworthy (e.g., hire influencers and marketers),—because TRUST is the new currency.

Online businesses or platforms also struggle. Reliable platforms who operate ethically find it difficult to enter a highly competitive marketplace that has new businesses emerging daily. If platforms want to be relevant and survive in the marketplace, they have to offer their businesses quickly and cost effectively which means they don't have the time to incorporate legal and regulatory requirements, which take a lot of time and resources. This makes new platforms at high risk for liability lawsuits, often exposed to unfair reviews, and unreasonable customer demands.

Only a small percentage of consumers report scams or unfair business practices and that is only when the amount of the deceit is substantial and/or is repeated. An even smaller percentage of businesses report unfair consumer demands, and unjust reviews, fearing that it will damage their online reputation and status. In situations where platforms and consumers have gone to legal battles, resolution and recourse have been extremely difficult due to the fact that current laws for the marketplace are unclear.

Establishing trust for brick-and-mortar businesses has traditionally been accomplished through various mechanisms. Traditional certification and accreditation practices involve many large organizations certifying against established international and national standards. In some regulated industries, certification to national or international standards is legally required to operate. Certification against international standards, national standards or best industry practices helps enterprises build confidence with partners, facilitate exports and imports, and provides confidence for consumers who purchase the products and services. Furthermore, a brick-and-mortar business can show legitimacy through the actual physical presence of a business in a physical location.

Establishing trust for an online platform has traditionally been accomplished through other mechanisms. Online reviews have become the main mechanism through which platforms solidify their accountability and build confidence. In addition, by adding hashtags, people and organizations try to build confidence in their product or service by establishing a relationship with a trusted party. Influencers have become another mechanism for building trust mechanisms. If a trusted person who is admired is endorsing a product or service, the consumer will believe it is credible. Being cited or represented by a media authority is an additional form of confidence-building. The assumption is that “someone has checked” that the given information is true.

Present solutions involving traditional forms of certification are often expensive, time-consuming, resource-intensive, and poorly applicable to online businesses. A lack of resources (both time and money) and an inapplicability of regulatory requirements to online platforms, mean that platforms are currently left with two main options to build trust online:

A: Implement minimum legal requirements either by imitating what other platforms have done (adopting the rationale: “if they can do it so can I”) or by receiving limited advice on legal issues.

B: Ignore requirements and launch an online business as soon as possible. Spend money on marketing, influencers and hashtags to generate positive reviews and drive traffic to the web site.

For both cases, current computing software and hardware do not provide technology for enabling a platform to prove trustworthiness. The only technology available is through provision of online reviews of their own website, or others, or embedding hashtags. None of these is sufficient to prove a company is legitimate, and there is typically no brick-and-mortar building or a physical space for a consumer to visit in order to assess a platform's legitimacy and integrity. A new technology and a new methodology is required.

Furthermore, current reviews are insufficient since they do not distinguish between online platforms and physical businesses (e.g. construction companies, media and communication, restaurants, hotels, esthetic services, etc.,). Current reviews focus on the service and goods provided and NOT the business practices of the organization (e.g., is the online platform transparent, accountable, reliable, safe, legal, liable, ethical, compliant, etc.). Current assessments fall into 2 categories:

1. Assessments (reviews) done by consumers (many) without set criteria; and

2. Assessments done by one organization with set criteria.

Neither of the above assessments serves to provide proof of legitimacy and ethical behaviour of an online platform.

### SUMMARY

The present invention provides a system which results in a mark of trust built for digital platforms. The system connects independent assessors, i.e. Trust Agents (TAs), with online businesses or platforms. Trust Agents evaluate and assess a platform against expectations, such as those contained in national/international regulations, government policies, standards, and industry best practices. Subsequently, based on the Trust Agents assessment, a report is produced for the platform, which may be cumulative. The report results and a Collabofide mark of trust, such as a logo, may be used to communicate the platform's commitment and performance to national regulation, international standards and industry best practices.

In one aspect, the present invention sets forth a digital, automated, assessment system. The system provides assistance to platforms to implement ethical and safe business practices and be endorsed by users for the effort. The system also enables consumers (Trust Agents) with the right tools and knowledge to distinguish between platforms which implement ethical practices and are reliable and safe, and those that are not. New types of employment possibilities are created through use of the tool for additional income for marginalized communities, people with disabilities, new citizens, students, people who want to reintegrate in the workforce (stay at home parents), and those who want to improve their skills and knowledge in order to be more competitive for promotions and positions in the employment market.

In one aspect, the present invention provides:
Assessor training for consumers, enabling consumers to be assessors
Digital literacy, providing new skills and employment opportunities
International standards training and information to platform operators, e.g. capacity building
A tool to complete an assessment of an online platform by a trained consumer (Trust Agent) and compare the merits and capabilities of the online platform against national regulations, standards and best practices, thereby building awareness and knowledge in existing safety and regulatory requirements
Compensation to the assessors (TAs)
Report based on the assessment
Website or display showing the report
A mark of trust for the online platform
Ongoing support for platforms and Trust Agents
Recognition by regulatory bodies and other organizations and businesses
Reputation building mechanism

The Collabofide mark of trust is comparable to the Better Business Bureau (BBB) mark of trust for brick-and-mortar businesses. However, the tool and methodology of the present invention is only applicable for online platforms and draws a sharp distinction between physical and virtual business offering and services. The tool empowers online businesses (platforms) to build trust and credibility to the online marketplace (and their business) by comparing them against national regulation, international standards and best practices. The present invention also creates knowledge and awareness for consumers on how to quickly assess if an online business is legitimate or not. The mark of trust equips a third party (a consumer, regulator, other) to quickly assess if a platform is a legitimate business.

In one aspect of the present invention, consumers take training, become onboarded through a recruitment process and/or approval process, and have the opportunity to become qualified assessors (Trust Agents). An online platform can volunteer to self-assess their capabilities and then the platform can pay qualified online auditors/assessors to assess the platform against international standards and best practices. This system enables the platform to be regulated automatically, without any concern or reference to the products sold on the platform.

In a further aspect, the present invention can also allow for geographic tracking. In this example, platforms can be legitimized to be endorsed by cities or other legislative bodies.

In yet a further aspect, the process levels the field between hard regulation, currently aimed at traditional forms of business, and no regulation at all for the online marketplace. The present system provides a physical technological tool that uses communities of users or consumers to measure, monitor and assess online platforms' adherence to established international standards and best practices. A new form of collaborative confidence building mechanism provides collaborative certification that uses international standards, best practices, and regulation as a benchmark.

In yet a further aspect of the present invention, there is provided a simplified, automatic assessment process that builds trust in the marketplace and is easy-to-use, affordable, fast, and reliable for platforms. The present system also enables consumers to gain expertise and knowledge in professional assessments, become assessors, make additional income, build skills which will enable them to seek promotions and alternative employment, and help build a trusted marketplace.

The present invention sets forth a digital conformity assessment tool for online platforms. In one aspect, the present invention proposes establishing smart online reviews by using paid consumer assessments against international standards and best practices for online platforms to demonstrate compliance and enhance their reliability and confidence. In this manner, an average consumer becomes an auditor and regular consumers who become auditors learn how to inspect properly. Such auditors can be paid for their services through money or other compensation measures. The present system provides assistance to platforms to implement ethical business practices and enables consumers with the right tools to know which platforms are ethical and reliable. Furthermore, the present system provides an automated conformity assessment.

In one aspect of the present invention there is provided a method comprising: training consumers to be assessors; providing knowledge of national regulations, international standards, and best practices to the assessors; completing an assessment of an online platform by comparing capabilities of the online platform against the national regulations, international standards, and best practices; producing a report based on the assessment; providing a mark of trust and providing access to the report via a website, logo, or display; and automatically updating the report in real-time each time a new assessment is completed.

In a further aspect of the present invention, there is provided a system comprising: a first platform having at least one capability for review by an assessor; a portal, provided from the first platform, configured to allow the assessor to select at least one capability from the first platform and use an assessment tool for assessment of the selected capability associated with the first platform; an analysis tool configured to store and manage a trigger that correlates data associated with results of the assessment tool to data associated with the selected capability; and a second platform configured to store a plurality of assessments, wherein the second platform allows a third party to track the selected capability within the plurality of assessments; wherein said tracked assessments are electronically sent to the first platform from the second platform, wherein the analysis tool comprises a recommendation engine configured to determine a rating/report based on the results of the assessment tool and the selected capability; and wherein the analysis tool automatically updates the rating/report in real-time each time a new assessment is completed.

In yet a further aspect of the present invention there is provided a system comprising: a review tool configured to enable an assessor to review capabilities of an online platform against national regulations, international standards, and best practices; an assessment tool configured to receive assessment and review data from the review tool and produce a compiled assessment; and a reporting tool configured to generate a platform report based on the compiled assessment performed by the assessment tool and to generate a mark of trust; wherein the reporting tool communicates the platform report and mark of trust to the online platform; wherein the assessment tool automatically updates the compiled assessment and the reporting tool automatically updates the platform report in real-time each time a new assessment is completed.

### BRIEF DESCRIPTION OF THE DRAWINGS

The invention will be further understood from the following description with reference to the attached drawings.

FIG. 1 illustrates a flow chart of the present system.

FIG. 2 illustrates an example report generated by the reporting tool.

FIG. 3 illustrates an example portion of the assessment and review tool.

### DETAILED DESCRIPTION

One aspect of the present invention provides collaborative and distributed assessments by using consumer assessments against international best practices for certification that is live, traceable, transparent, reliable, cost effective, automatic, and fast. In addition, the present system creates a new type of employment, using consumers' intellectual capacity in a new way to generate income. Since the present system use a gig economy platform, it allows consumers to be assessors and generate additional income.

Currently, consumers and online platforms are unaware of assessment, certification, and regulation practices. The present invention brings new awareness and knowledge of the minimum requirements for both platforms and consumers to safely navigate the online marketplace.

The present invention provides platforms with access to data, such as distributed data assessments showing statistical significance, volume of users, etc. In one aspect there is provided a website and an app running on IOS and Android devices. In one aspect, there are provided various tools, such as provision of reports, percentage of compliance, data collected—raw data and statistical analysis, new types of employment opportunities through hiring assessors, accessibility to new education and knowledge to learn how to become accredited as an assessor, a new type of confidence mark, such as a mark of trust or certification for online platforms, new standards and regulations applicable to online platforms, recruitment for people who want to participate in the standards development process, and recruitment of people who want to be auditors.

In a further aspect of the present invention, there is provided evaluation of programs and initiatives, both for profit and not-for-profit, temporary or long term, instigated by government and NGO's, national or international. Traditional forms of certification bodies are replaced with an automatic system while providing assurance to regulators, such as cities, municipalities, professional colleges and registrars, etc. The present system further provides an education tool for online businesses and consumers as well as a recruitment platform for people who are interested in participating in standards development.

In one aspect of the present invention, the system provides intelligence to regulatory authorities, such as the Consumer Council of Canada, Standards Council of Canada, and others, respecting consumers' sentiment regarding a regulation or rule. For example, one can determine how consumers rate the applicability to the Privacy Act or government Complaints Handling Mechanism for online platforms.

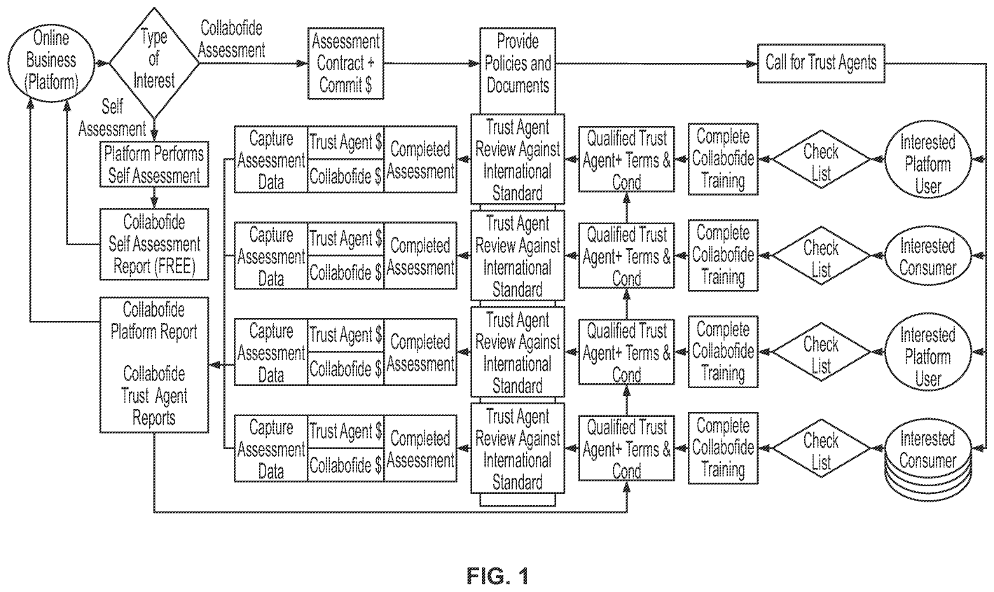

FIG. 1 shows a flow chart of one embodiment of the process of the present invention. A self-assessment tool permits a platform to determine interest and produce a self-assessment report. If the interest of the online platform is positive, the platform proceeds into an assessment contract tool. Once the online platform is accepted into the system, a request is sent for TAs to begin evaluation of the platform.

In order for interested consumers and platform users to enter into the tool and become TAs, they must first access a check list tool and use a training tool to become qualified assessors. Once the training tool is complete, the system certifies the interested platform users and consumers as qualified TAs. A review tool permits certified TAs to review an online platform by comparing merits or capabilities or categories related to the online platform against national regulations, international standards, and best practices. Once the review tool is complete, assessment and review data produced during operation of the review tool are captured and an assessment tool produces a compiled assessment. The assessment tool is configured to compile and correlate data associated with the results of the review tool to stored data associated with the capabilities. The TAs are compensated and a reporting tool generates a platform report based on the compiled assessment performed by the assessment tool which is provided to the online platform. The reporting tool also evaluates and assesses each TA for consistency and trustworthiness to ensure terms and conditions of the contract are being satisfied. A mark of trust is provided to the online platform and may be used to communicate the platform's commitment and performance to national regulation, international standards and industry best practices. The mark of trust can be a website, logo or display. The online platform can optionally provide access to the results of the platform report and/or can optionally provide a simple score indicating the average result of the online platform over all of the categories.

In a further aspect, the present invention can also allow for geographic tracking. In this example, the best practices and regulations included in the review tool can include those related to endorsement required by cities or other legislative bodies.

Online platforms using the present invention will be able to establish a rating based on assessments performed by regular consumers against international standards and best practices. In one example, the rating is a cumulative score from all the assessments conducted, where there requires a minimum of, for example, five assessments and the maximum depends on the size of the platform. In one aspect of the present invention, a history of assessments completed can be shown to the consumer to reflect increases or decreases in ratings over time. Essentially, consumers can see where a platform excels vs. areas of improvement. For example, ratings may be based on the merits, categories and/or capabilities of the online platform against established criteria and/or expectations (national/international) relating to items such as shipping times, employee longevity, inquiry response time, inclusivity, environmental sustainability, integrity, etc.

In one aspect of the present invention, there are provided assessments that can be performed and updated in real time. Furthermore, the system operates automatically. In this manner, multiple assessors can evaluate an online platform simultaneously. As the assessors complete the review tool, the assessment tool automatically compiles and correlates the new data from the review tool to produce a new rating, report and/or score for the online platform. The updating of the rating, report and/or score also occurs automatically.

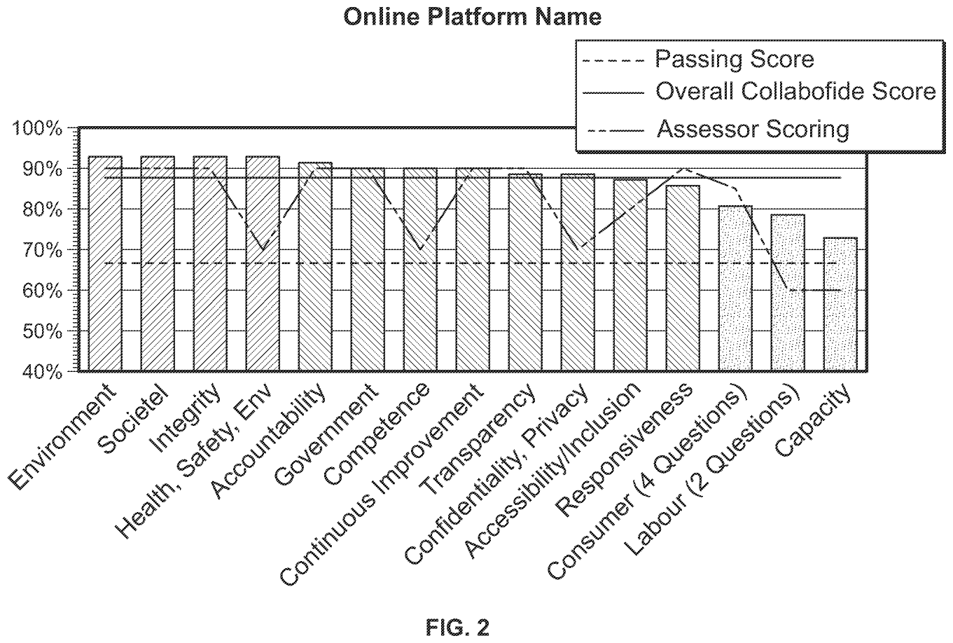

FIG. 2 shows an example report generated by the reporting tool. The passing score is marked with the dashed line and represents the minimum score necessary for an online platform to pass each category. The vertical axis provides the rating, while the horizontal axis provides the categories or capabilities or merits used during the review tool. The overall Collabofide score represents the overall score, while the assessor scoring reflects the individual results produced by the assessor during use of the review tool.

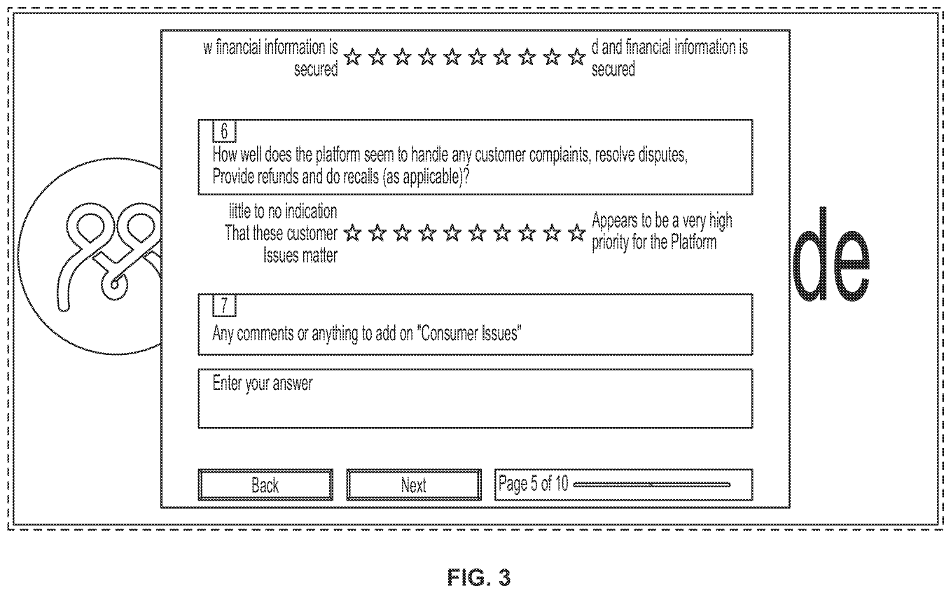

FIG. 3 shows an example portion of a sample of the review tool. The results of the review tool are provided to the assessment tool for compilation, comparison and/or correlation with other TA review results. The results of the assessment tool are provided to the reporting tool for provision to the online platform. Results can be displayed on the online platform along with insertion of a mark of trust to indicate that the online platform has been accepted into and participates in a certification platform. In one aspect, the results are not shown as a pass or fail, rather as a degree or score for each category of evaluation used in the review tool. As a further alternative, the results could be displayed as a total score averaged over all of the categories.

In another example embodiment, there is provided a portal from the online platform for allowing an assessor to select at least one capability from the online platform. The assessor executes an assessment tool for assessment of the selected capability associated with the first online platform. An analysis tool is configured to store and manage a trigger that correlates data associated with the results of the assessment tool to data associated with the selected capability. The data associated with the selected capability can be stored previously. A server or second platform can optionally store all of the assessments completed by various assessors. The second platform or server allows a third party to track the various capabilities of the online platform and view the results thereof. A communication channel or network can be used to send assessments from the server or second platform to the first platform. The analysis tool includes a recommendation engine configured to determine a rating and/or report based on the assessment and the selected capability. The rating and/or report are delivered to the first platform from the server or second platform. A mark of trust can be provided to the first platform from the server or second platform.

Following from the above description, it should be apparent to those of ordinary skill in the art that, while the methods and apparatuses herein described constitute exemplary embodiments of the present invention, the invention described herein is not limited to any precise embodiment and that changes may be made to such embodiments without departing from the scope of the invention as defined by the claims. For example, although the invention has been described with respect to an online platform assessment and compliance, the system and method can be used for various other virtual/automated/digital assessments. For example, the system and method could be used for 1) internal organizational performance reviews; 2) virtual recruitment, both national and international; 3) government grants and funding; 4) investors for assessing the legitimacy and integrity of companies they want to invest in, etc.

Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method comprising:
training consumers to be assessors;
providing knowledge of national regulations, international standards, and best practices to the assessors;
completing an assessment of an online platform by comparing capabilities of the online platform against the national regulations, international standards, and best practices;
producing a report based on the assessment;
providing a mark of trust and providing access to the report via a website, logo, or display; and
automatically updating the report in real-time each time a new assessment is completed.

2. The method of claim 1 further comprising the step of providing a self-assessment report for a new online platform.

3. The method of claim 2 further comprising the step of providing an assessment contract to the new online platform.

4. The method of claim 1 wherein the step of comparing the capabilities of the online platform is performed by the assessors through a review tool.

5. The method of claim 4 wherein the step of completing an assessment is performed by an assessment tool that is configured to compile and correlate data associated with results of the review tool to stored data associated with the capabilities.

6. The method of claim 1 further comprising the step of providing compensation to the assessors.

7. The method of claim 1 further comprising the step of evaluating the assessors for consistency and trustworthiness.

8. The method of claim 1 wherein the step of comparing the capabilities of the online platform includes geographic tracking.

9. The method of claim 1 wherein the step of providing access to the report includes providing access to historical data.

10. A system comprising:
a first platform having at least one capability for review by an assessor;
a portal, provided from the first platform, configured to allow the assessor to select at least one capability from the first platform and use an assessment tool for assessment of the selected capability associated with the first platform;
an analysis tool configured to store and manage a trigger that correlates data associated with results of the assessment tool to data associated with the selected capability; and
a second platform configured to store a plurality of assessments, wherein the second platform allows a third party to track the selected capability within the plurality of assessments;
wherein said tracked assessments are electronically sent to the first platform from the second platform,
wherein the analysis tool comprises a recommendation engine configured to determine a rating/report based on the results of the assessment tool and the selected capability; and
wherein the analysis tool automatically updates the rating/report in real-time each time a new assessment is completed.

11. The system of claim 10 further comprising a mark of trust that is provided to the first platform from the second platform.

12. The system of claim 10 wherein the second platform comprises the analysis tool.

13. The system of claim 10 wherein the second platform is configured to deliver the rating/report to the first platform electronically.

14. The system of claim 10 further comprising a communication channel for communication between the first platform and the second platform.

15. The system of claim 10 wherein the second platform is a server.

16. The system of claim 15 wherein the assessment tool includes geographic tracking.

17. The system of claim 10 wherein the rating/report includes historical data.

18. A system comprising:
a review tool configured to enable an assessor to review capabilities of an online platform against national regulations, international standards, and best practices;
an assessment tool configured to receive assessment and review data from the review tool and produce a compiled assessment; and
a reporting tool configured to generate a platform report based on the compiled assessment performed by the assessment tool and to generate a mark of trust;
wherein the reporting tool communicates the platform report and mark of trust to the online platform;
wherein the assessment tool automatically updates the compiled assessment and the reporting tool automatically updates the platform report in real-time each time a new assessment is completed.

19. The system of claim 18 wherein the reporting tool evaluates and assesses each assessor for consistency and trustworthiness.

20. The system of claim 19 wherein the assessment tool is configured to compile and correlate the assessment and review data against stored data associated with the capabilities.

21. The system of claim 18 further comprising a check list tool and training tool for training new assessors.

22. The system of claim 18 further comprising a self-assessment tool for an online platform to self-assess.
